(19) United States
(12) Patent Application Publication
(10) Pub. No.: US 2015/0160038 A1
(43) Pub. Date: Jun. 11, 2015

(54) RENDERING OF UTILITIES, VALVES, INFORMATION AND UTILITY ASSETS INTO 360 DEGREE INTERACTIVE PHOTOGRAPHY

(71) Applicant: Eliot Kirkpatrick, Indianapolis, IN (US)

(72) Inventor: Eliot Kirkpatrick, Indianapolis, IN (US)

(21) Appl. No.: 14/607,674

(22) Filed: Jan. 28, 2015

Related U.S. Application Data
(63) Continuation-in-part of application No. 14/183,924, filed on Feb. 19, 2014.
(60) Provisional application No. 61/914,140, filed on Dec. 10, 2013.

(51) Int. Cl. G01C 21/36

(52) U.S. Cl. CPC G01C 21/3697; G01C 21/3673

(57) ABSTRACT

A photographic arrangement includes a camera capturing 360 degree or panoramic photographic images of a roadway as the camera is carried by a motor vehicle along the roadway. Locations of the vehicle are determined in association with the photographic images captured by the camera. An image processing circuit retrieves information about an asset associated with the roadway, the information including a location of the asset. The information is superimposed as text onto the photographic images. The text is disposed at respective positions within the photographic images. The positions are indicative of the location of the asset relative to the roadway.

### RELATED APPLICATIONS

This application is a continuation-in-part of, and claims the benefit of, U.S. patent application Ser. No. 14/183,924, filed Feb. 19, 2014, which is a non-provisional of, and claims the benefit of, U.S. provisional application 61/914,140, filed Dec. 10, 2013, both entitled “2D/3D Analysis and Rendering of Utilities, Valves, Information and Assets into Video”, by applicant Eliot Kirkpatrick, both of which are hereby incorporated by reference herein in their entirety.

### BACKGROUND OF THE INVENTION

1. Field of the Invention

The invention may relate to associating information with images, such as video footage and photography, and storing the information in association with particular portions of the images. The invention may also relate to the identification and documentation of assets.

2. Description of Related Art

Currently, there are a number of ways to document important assets within a construction (or deconstruction) project, with pictures and videos being the most predominant. For example, if there is to be road or sidewalk construction done on a project, documentation may be taken of all utilities, valves, hydrants, and other important assets so they remain intact throughout the work period of the project and to establish liability on the part of the contractor hired in the event that some damage occurs during the project.

Utility equipment such as for natural gas, water, steam, sanitary sewer, electrical, and fiber optic cable is often inadvertently cut or damaged during construction projects. Every year, thousands of utility lines/pipes are damaged due to ongoing construction costing millions in unexpected costs as well as time. Current methods of utility location simply include painting the location of the utilities and showing no further information.

### BRIEF SUMMARY

A method includes an online, interactive way to approximate the location of underground utilities and their corresponding information through means of 360 degree field of view photography and online display using HTML5, CSS, and JavaScript. This online display superimposes the graphical data of each utility gathered in the field and allows the user to view multiple types of information including: depth of utility, previous work orders, type of pipe, GPS coordinates, and more.

The present invention may be directed to the identification, rendering, and editing of still 360-degree imagery to display certain assets and their associated information. Simply put, this process may graphically depict information into 360-degree interactive photography that displays the utilities themselves as well as their corresponding information. These photographs may depict all information regarding a given asset including but not limited to: previous work performed on a utility, diameter of pipe/line, asset identification number, owner of asset, and approximate location and depth of utilities underground.

The present invention may incorporate motion tracking and data implementation into a previously shot video of an area that will undergo future change (e.g., construction, landscaping, etc.). Once a video is captured of a designated area that will undergo change, information associated with assets may be gathered and, once collected, may be placed into the video by means of motion tracking and 2D/3D rendering software. The final product may contain each asset/valve/utility, and each asset/valve/utility may be individually documented, including associated measurements, asset numbers, addresses, and any other information that may be available.

The stored information may include results of the identification, rendering, and motion tracking of a video to display certain assets and information corresponding to the assets in video format. Generally, the method of the invention may include graphically depicting information into moving video for any asset or item of interest. These assets along with their information may move through the field of view in a first person style of vision.

The invention may enhance a video style by rendering asset information onto a video display. Every asset may be individually documented and labeled to move through the three-dimensional plane of the video taken of each project.

By displaying a current representation of location and information relating to each asset, anyone with an Internet connection can view the utility information from any mobile device or computer.

The invention may be beneficial to a variety of fields including: project management, engineering, utility companies, and utility locating companies. This may be due to the interactivity and responsive way the utilities are displayed in the online display enabling a user to look in any direction in a 360 degree range, see all utilities and their associated information, and look and move from address to address without ever leaving the same webpage. Thus, project managers and engineering firms may be enabled to remotely and periodically monitor their current construction or land altering projects to limit the associated cost and occurrence of cutting utility lines and pipes, therefore saving money and lowering overall project duration.

A practical example for the application this product would be a construction project manager attempting to maintain utilities and their corresponding valves over the course of a project's duration. This invention may enable the project manager to monitor the location of each utility even if the locating paint laid at the beginning of the project has faded or has become covered. The invention may provide the user access to a much wider set of information, thereby helping to eliminate lost time and money associated with cutting or damaging a utility.

The invention may use 360-degree panoramic style photography to document utilities in a project by means of rendering asset information onto a 360-degree field of view, resulting in the ability to display assets/information in all directions. Every asset may be individually documented and labeled to move through a user guided interactive display, enabling users to choose their current direction of sight to display information, as well as enabling them to move to the next available 360 degree photo of the project without first redirecting to another web page.

The present invention may incorporate 360-degree photography and data implementation to create an altered image able to be viewed by means of a mobile device or computer with an Internet connection. The invention may display the location and associated information of a given asset/utility and may enable remote monitoring of an ongoing or upcoming project involving utilities. Once a still 360-degree photograph has been taken of a designated area, information about the assets/utilities within the project boundaries may be gathered and then placed into the original photograph through means of photo editing software. The final product may depict each asset/valve/utility, which may each be individually documented with measurements, asset number (if available), address, and any other information available. This final product may be available via a web hyperlink from any device with an Internet connection.

The invention comprises, in one embodiment, a photographic arrangement including a motor vehicle and a camera capturing photographic images of a roadway as the camera is carried by the motor vehicle along the roadway. Determining means determines a plurality of locations of the vehicle in association with the photographic images captured by the camera. An image processing circuit retrieves information about an asset associated with the roadway. The information includes a location of the asset. The image processing circuit superimposes the information as text onto the photographic images. The text is disposed at respective positions within the photographic images. The positions are indicative of the location of the asset relative to the roadway.

The invention comprises, in another embodiment, an image processing method, including capturing a plurality of photographic images of a roadway. Information about an asset associated with the roadway is retrieved. The information includes a location of the asset. The information is superimposed as text onto the photographic images. The text is disposed at respective positions within the photographic images. The positions are indicative of the location of the asset relative to the roadway.

The invention comprises, in yet another embodiment, a photographic arrangement including a camera capturing photographic images of an external environment as the camera is carried by a motor vehicle. Determining means determines a plurality of locations of the vehicle in association with the photographic images captured by the camera. An image processing circuit retrieves information about an asset associated with the external environment. The information includes a location of the asset. The image processing circuit superimposes the information as text onto the photographic images. The text is disposed at respective positions within the photographic images. The positions are indicative of the location of the asset within the photographic images.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a block diagram of one embodiment of a video arrangement of the present invention;

FIG. 2 is a flow chart of one embodiment of a video recording method of the present invention;

FIG. 3 is a plan view of an example video screen display produced by the arrangement of FIG. 1;

FIG. 4 is a flow chart of another embodiment of a video recording method of the present invention;

FIG. 5 is a partial view of another example video screen display produced by the arrangement of FIG. 1 in the form of a full 360-degree panoramic image of an intersection is displayed showing natural gas, water, and sanitary sewer utilities; and

FIG. 6 is a partial view of yet another example video screen display produced by the arrangement of FIG. 1 in the form of a full 360-degree panoramic image of the intersection of FIG. 5 displayed showing natural gas, water, and sanitary sewer utilities.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

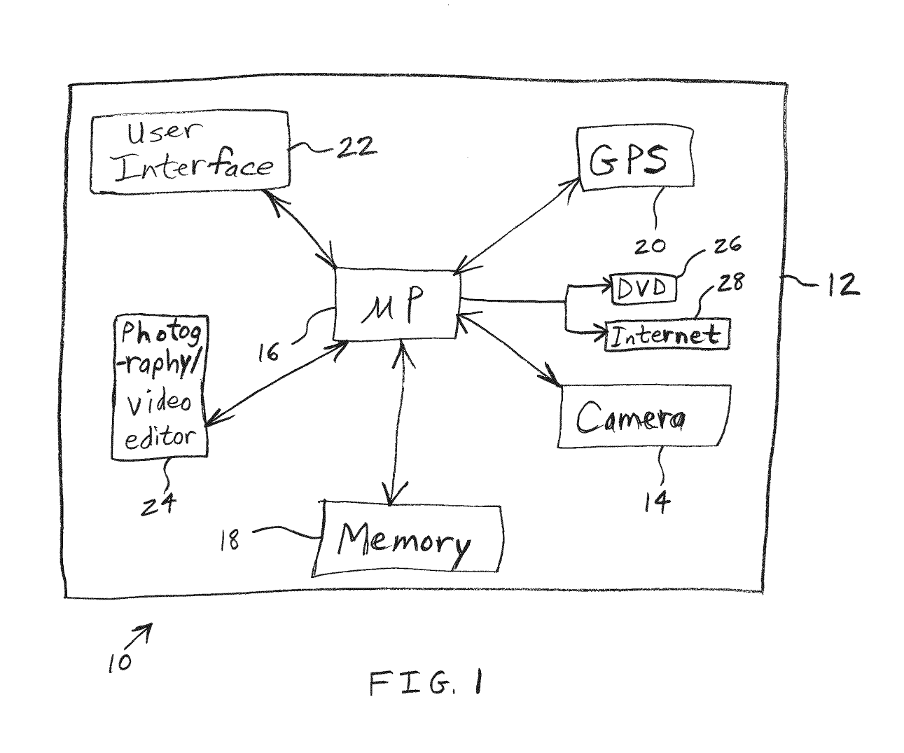

One embodiment of an apparatus of the present invention in the form of a video arrangement 10 is shown in FIG. 1. Arrangement 10 may be disposed within a motor vehicle 12. However, all components with the possible exception of camera 14 may alternatively be disposed at a remote location and not be carried by vehicle 12. Arrangement 10 also includes a processor 16, a memory device 18, a global positioning device (GPS) 20, a user interface 22 and a photography/video editor 24. Processor 16 may be in bi-directional communication with each of the other components of arrangement 10. Processor 16 and photography/video editor 24 may conjunctively form an image processing circuit or a video processing circuit.

During use, vehicle 12 may travel along streets with camera 14 operating and capturing video images of the streets. Camera 14 may capture at least one panoramic, 360 degree image at each of a plurality of discrete positions along the route. GPS 20 may operate continuously while camera operates, and processor 16 may associate each frame of video or 360 degree captured image with a respective set of GPS coordinates. Memory 18 may include a list of assets associated with the streets, and the GPS coordinates of each of those assets may be stored in memory 18 in association with each of the assets. Processor 16 may use the retrieved GPS locations of the assets to superimpose a textual identification of each of the assets on the video frames. Each of the textual identifications may be located on the frames at a location corresponding to the GPS-determined location of the respective asset. For greater precision, arrows may also be superimposed on the frames to show more exact locations on the ground or streets that correspond to the locations of the various assets. The assets may be buried below ground, and hence may not be visible in the video frames. A user may use user interface 22 to add to the textual descriptions or identifications of the assets that are displayed on the video frames. For example, user interface 22 may include a keyboard or voice recognition equipment and software to enable the inputting of text. The identifications or descriptions of the assets may include an asset name or number, a street address of the assets, type of casting, and measurements of the distance of the assets from landmarks, such as cross streets (e.g., streets crossing the street being traveled on) or the distance of the assets from one of the two curbs of the street being traveled on.

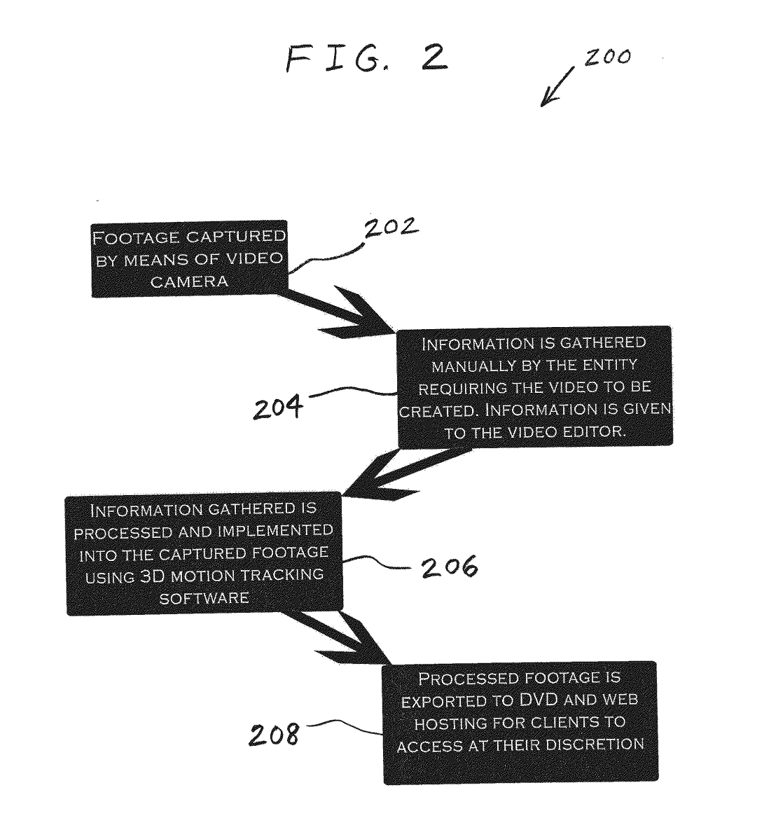

FIG. 2 is a flow chart of one embodiment of a video recording method 200 of the present invention. Method 200 may result in the capturing and implementing of video and textual information into a final video format for the end user (client) to use upon demand.

In a first step 202, footage is captured by use of a video camera. For example, camera 14 may capture video footage as vehicle 12 travels along streets. It is also possible for a camera to be carried by a robotic device or by a pedestrian as footage is captured.

In a next step 204, information is gathered manually by the entity that is requiring the video to be created. Information is given to the video editor. For example, identifications, descriptions and locations of the assets that are associated with the street images captured in the footage are collected by performing measurements on the streets and/or collecting existing asset data from other sources. The collected information may be entered into video editor 24 via user interface 22 and processor 16, for example. The information may also be stored in memory 18.

Next, in step 206, the information that has been gathered in step 204, may be processed and implemented into the captured footage using three-dimensional motion tracking software. That is, motion tracking software running on processor 16 may superimpose text information about assets into the individual frames of video footage with arrows indicating the precise locations of the assets in the individual frames. As the vehicle moves relative to the street, the locations of the text and arrows in the individual video frames may change or shift, as determined by the 3D motion tracking software, due to the changing locations of the assets within the individual video frames. For example, the location near a curb of a street being traveled on may move from the center portion of the frames to the side portions of the frames as the asset is approached and eventually passed.

In a final step 208, processed footage is exported to DVD and web hosting for clients to access at their discretion. That is, the video footage with the text information superimposed thereon may be stored on a digital video disc (DVD) 26 (FIG. 1) or may be made available on the Internet 28.

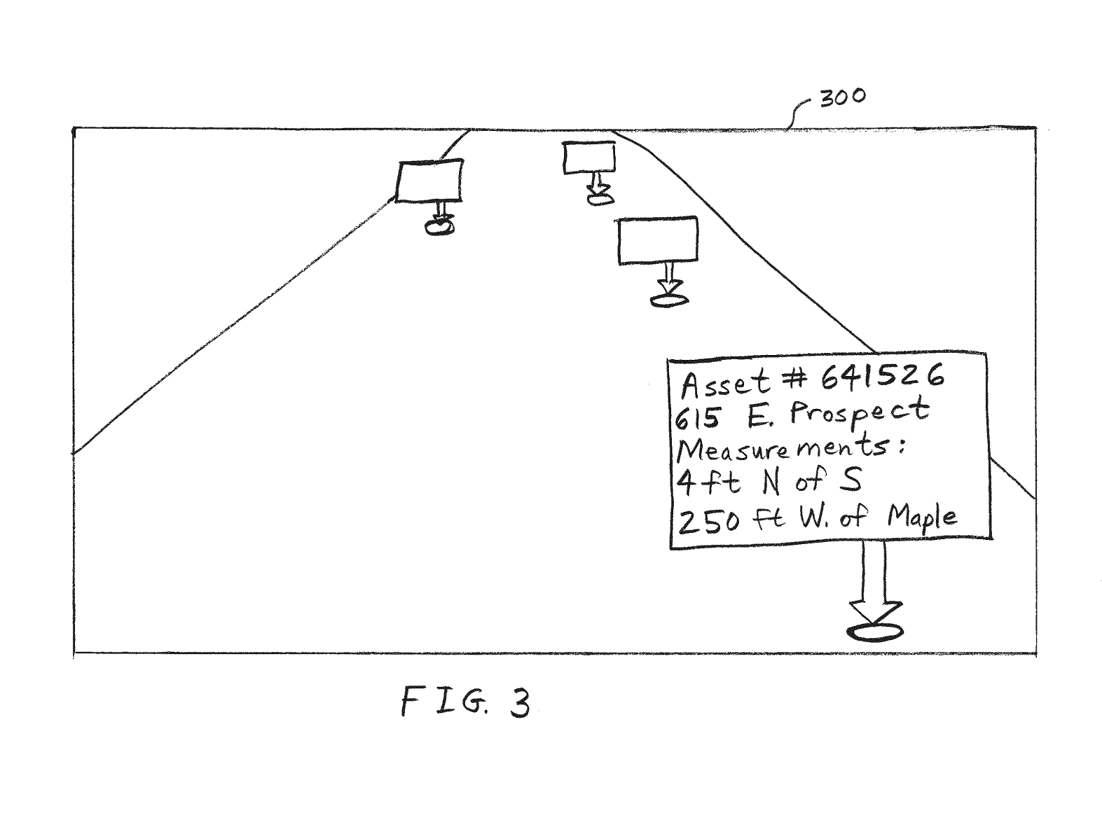

FIG. 3 is a plan view of an example video screen display 300 produced by the arrangement of FIG. 1. A natural gas valve is shown in the lower right-hand corner of the screen with an arrow pointing to the valve. A flag displays text information related to the valve. In one embodiment, the flag includes black lettering on a yellow background to display a natural gas color code. That is, the yellow background may indicate to the user that the asset is related to natural gas. The information may include the asset number, address, and measurements. Three upcoming, or more distant, utilities/assets are visible in the background of FIG. 3. The text associated with these three farther away assets may get larger and move more into view as video progresses and the vehicle continues to travel along the street.

The names of cross streets in the distance may be superimposed in the video frames. Other types of assets may have a different color coded text background. For example, a flag associated with a sanitary sewer utility may have a green background with black text. Other upcoming utilities and street signs may be color coded as appropriate. For example, a superimposed street sign of an upcoming cross street may have white lettering on a dark green background. A flag associated with a water utility may have a blue background and black text to indicate that the asset is related to a water utility.

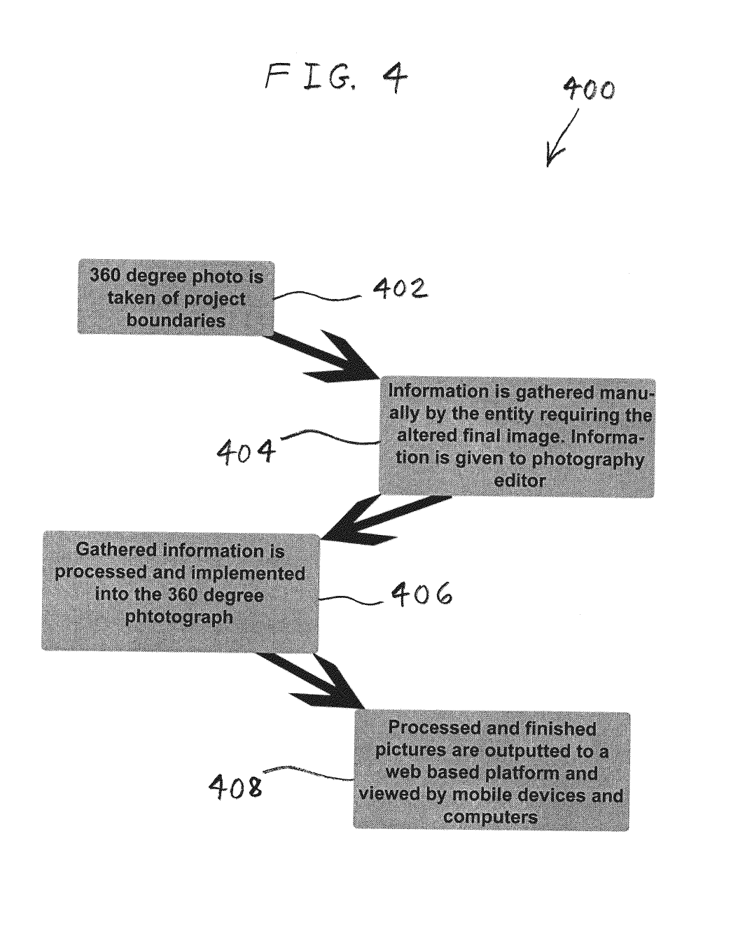

FIG. 4 is a flow chart of one embodiment of a 360 degree image recording method 400 of the present invention. Method 400 may result in the capturing and implementing of video and textual information into a final video format for the end user (client) to use upon demand. Method 400 may also result in the creation of a 360 degree altered photograph displaying utility assets and information.

In a first step 402, a 360 degree photograph is taken of project boundaries. For example, camera 14 may capture a 360 degree panoramic photograph of the portions of a street or streets, or intersecting streets on which a construction or deconstruction project will take place. Such 360 degree panoramic photographs may be taken at several positions within the project boundaries. For example, camera 14 may capture a plurality of 360 degree panoramic photographs as vehicle 12 travels along streets. It is also possible for a camera to be carried by a robotic device or by a pedestrian as footage is captured.

In a next step 404, information is gathered manually by the entity that is requiring the altered final image Information is given to the photography editor. For example, identifications, descriptions and locations of the assets that are associated with the street images captured in the footage are collected by performing measurements on the streets and/or collecting existing asset data from other sources. The collected information may be entered into photography editor 24 via user interface 22 and processor 16, for example. The information may also be stored in memory 18.

Next, in step 406, the information that has been gathered in step 404, may be processed and implemented into the 360 degree photographs. That is, 3D motion tracking software running on processor 16 may superimpose text information about assets into the 360 degree photographs with arrows indicating the precise locations of the assets in the photographs. As the vehicle moves relative to the street, the locations of the text and arrows in the individual photographs may change or shift, as determined by the 3D motion tracking software, due to the changing locations of the assets within the individual photographs. For example, the location near a curb of a street being traveled on may move from the center portion of the photographs to the side portions of the photographs as the asset is approached and eventually passed.

In a final step 408, processed and finished photographs are outputted to a web-based platform and viewed by mobile devices and computers. That is, the photographs with the text information superimposed thereon may be made available on the Internet 28 for viewing by any Internet-compatible device.

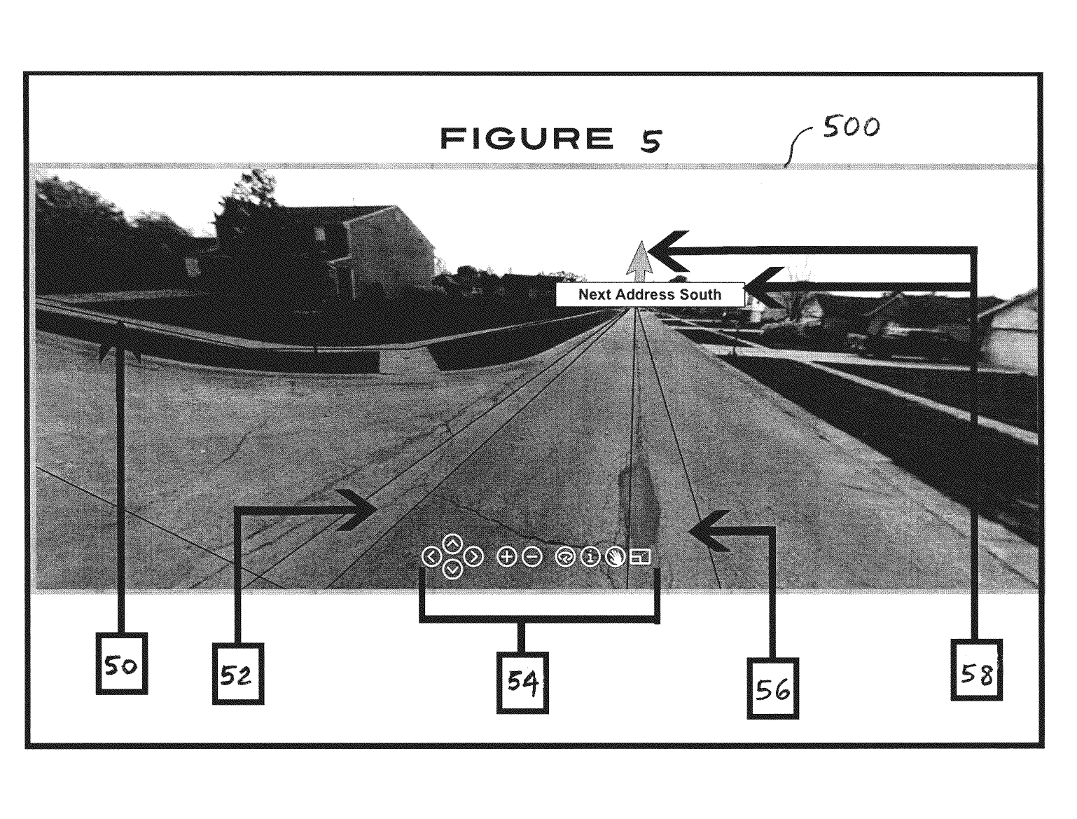

FIG. 5 is a plan view of an example video screen display 500 produced by the arrangement of FIG. 1, including a partial view of a 360 degree photograph. The photograph in display 500 spans approximately 90 degrees.

As indicated at 50, a line or other shape indicates the location of a natural gas conduit which is buried under the sidewalk. When a computer mouse hovers over this line 50, all information about the buried natural gas conduit may be displayed in a pop up box on the screen. In one embodiment, line 50 is superimposed on screen by yellow, semitransparent highlighting in order to make line 50 easier to see.

As indicated at 52, a strip or other shape following the roadway indicates the location of a buried water pipe. When a computer mouse hovers over this strip 52, all information about the buried water pipe may be displayed in a pop up box on the screen. In one embodiment, strip 52 is bordered by two opposing black lines and is superimposed on screen by blue, semitransparent highlighting in order to make strip 52 easier to see.

As indicated at 54, a navigational menu is displayed allowing the user to look in all directions, zoon in and out, turn auto rotation on and off, display location and copyright information, and maximize the viewer to full screen.

As indicated at 56, a strip or other shape following the roadway indicates the location of a buried sanitary sewer pipe. When a computer mouse hovers over this strip 56, all information about the buried sanitary sewer pipe may be displayed in a pop up box on the screen. In one embodiment, strip 56 is bordered by two opposing black lines and is superimposed on screen by a bright green, semitransparent highlighting in order to make strip 56 easier to see.

As indicated at 58, an arrow, which may be orange in color, for example, is being hovered over by a computer mouse. Upon the mouse hovering over this arrow, a pop up box immediately displays information on which direction the user wants to go to next. Upon the mouse being used to click upon this arrow, a new image is loaded onto the screen displaying the next address south of the current location where the picture of FIG. 5 was taken.

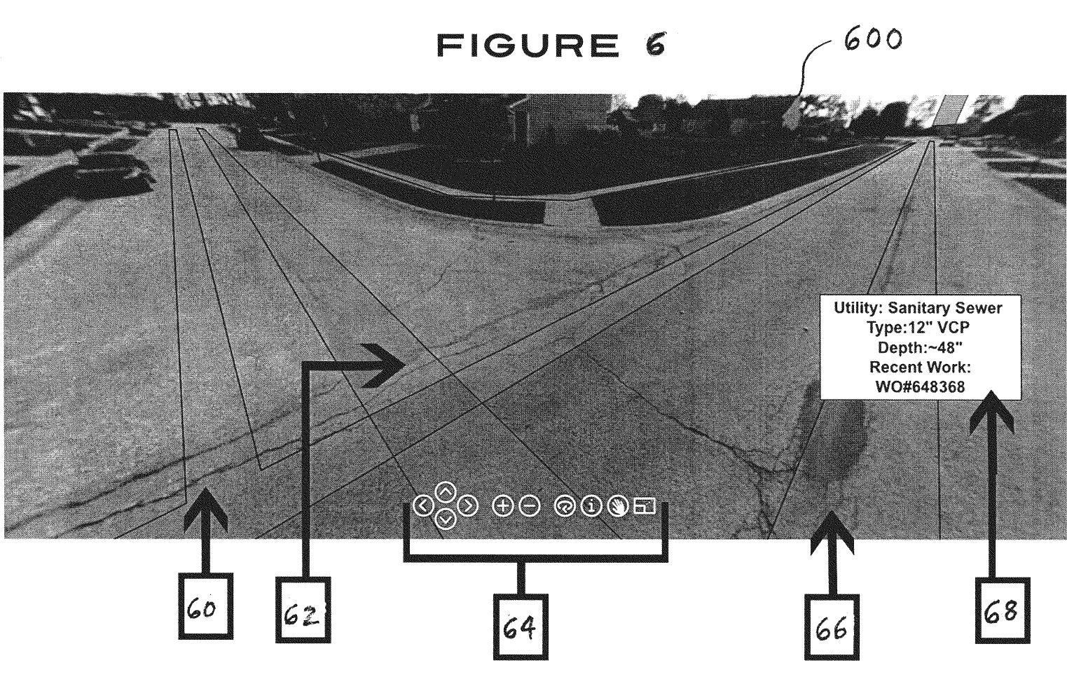

FIG. 6 is a plan view of another example video screen display 600 produced by the arrangement of FIG. 1, including a partial view of a 360 degree photograph. The photograph in display 600 spans approximately 90 degrees. More particularly, the photograph in display 600 is a portion of the same 360 degree photograph illustrated in FIG. 5, but is rotated about twenty degrees in a counterclockwise direction therefrom.

As indicated at 60, a strip or other shape following the roadway indicates the location of a buried water pipe. When a computer mouse hovers over this strip 60, all information about the buried water pipe may be displayed in a pop up box on the screen. In one embodiment, strip 60 is bordered by two opposing black lines and is superimposed on screen by a blue, semitransparent highlighting in order to make strip 60 easier to see.

As indicated at 62, a strip or other shape following the roadway indicates the location of a buried sanitary sewer pipe. When a computer mouse hovers over this strip 62, all information about the buried sanitary sewer pipe may be displayed in a pop up box on the screen. In one embodiment, strip 62 is bordered by two opposing black lines and is superimposed on screen by a bright green, semitransparent highlighting in order to make strip 62 easier to see.

As indicated at 64, a navigational menu is displayed allowing the user to look in all directions, zoon in and out, turn auto rotation on and off, display location and copyright information, and maximize the viewer to full screen.

As indicated at 66, a strip or other shape following the roadway indicates the location of a buried sanitary sewer pipe. When a computer mouse hovers over this strip 66, all information about the buried sanitary sewer pipe may be displayed in a pop up box on the screen. In one embodiment, strip 66 is bordered by two opposing black lines and is superimposed on screen by a bright green, semitransparent highlighting in order to make strip 66 easier to see.

As indicated at 68, the user has hovered the mouse over the sanitary sewer indicated at 66 and the pop up menu displays the information gathered on this particular asset.

The invention has been described herein as illustrating the location of assets relative to a roadway. However, it is to be understood that the invention is applicable to a vehicle traveling in any external environment which may or may not include streets or roadways. For example, the invention may be applied to a boat traveling along a waterway, or to an off-road vehicle traveling in an off-road environment that does not have any established paths, streets or roadways.

Although this invention has been described in specific detail, it will be understood that many variations and modifications may be effected within the scope and spirit of the invention as described in the description and claims.

What is claimed is:

1. A photographic arrangement, comprising:
a motor vehicle;
a camera configured to capture photographic images of a roadway as the camera is carried by the motor vehicle along the roadway;
means for determining a plurality of locations of the vehicle in association with the photographic images captured by the camera; and
an image processing circuit configured to:
retrieve information about an asset associated with the roadway, the information including a location of the asset; and
superimpose the information as text onto the photographic images, the text being disposed at respective positions within the photographic images, the positions being indicative of the location of the asset relative to the roadway.

2. The arrangement of claim 1, wherein the image processing circuit is configured to:
retrieve a name of a street that crosses the roadway; and
superimpose the name as text onto the photographic images.

3. The arrangement of claim 1, wherein the determining means comprises a global positioning system.

4. The arrangement of claim 1, wherein the camera is configured to capture panoramic 360 degree photographic images of a roadway as the camera is carried by the motor vehicle along the roadway.

5. The arrangement of claim 1, wherein the image processing circuit is configured to export the photographic images with the text information superimposed thereon to a digital video disc.

6. The arrangement of claim 1, wherein the image processing circuit is configured to export the photographic images with the text information superimposed thereon to the Internet.

7. The arrangement of claim 1, wherein the information includes an identification of the asset.

8. An image processing method, comprising the steps of:
capturing a plurality of photographic images of a roadway;
retrieving information about an asset associated with the roadway, the information including a location of the asset; and
superimposing the information as text onto the photographic images, the text being disposed at respective positions within the photographic images, the positions being indicative of the location of the asset relative to the roadway.

9. The method of claim 8, wherein the capturing step is performed by a camera carried by a vehicle along the roadway;

10. The method of claim 9, further comprising the step of determining a plurality of locations of the vehicle in association with the photographic images captured by the camera.

11. The method of claim 10, wherein the determining is performed by a global positioning system.

12. The method of claim 8, comprising the further steps of:
displaying a first one of the photographic images on a screen;
including an arrow in the displayed first photographic image; and
in response to the user using a computer mouse to click on the arrow, displaying a second one of the photographic images on the screen, the second photographic image having been captured at a second location disposed in the direction of the arrow from a first location at which the first photographic image was captured.

13. The method of claim 8, wherein the photographic images comprise panoramic 360 degree photographic images.

14. The method of claim 8, comprising the further step of exporting the photographic images with the text information superimposed thereon to a digital video disc.

15. The method of claim 8, comprising the further step of exporting the photographic images with the text information superimposed thereon to the Internet.

16. The method of claim 8, wherein the information includes an identification of the asset.

17. A photographic arrangement, comprising:
a camera configured to capture photographic images of an external environment as the camera is carried by a motor vehicle;
means for determining a plurality of locations of the vehicle in association with the photographic images captured by the camera; and
an image processing circuit configured to:
retrieve information about an asset associated with the external environment, the information including a location of the asset; and
superimpose the information as text onto the photographic images, the text being disposed at respective positions within the photographic images, the positions being indicative of the location of the asset within the photographic images.

18. The arrangement of claim 17, wherein the image processor is configured to superimpose a representation of the asset on the photographic images, the representation comprising at least one of a line, a strip and colored highlighting.

19. The arrangement of claim 17, wherein the image processing circuit is configured to export the photographic images with the text information superimposed thereon to a digital video disc and/or to the Internet.

20. The arrangement of claim 17, wherein the information includes an identification of the asset.
